(19) United States
(12) Patent Application Publication
(10) Pub. No.: US 2009/0256115 A1
(43) Pub. Date: Oct. 15, 2009

(54) COLLOIDAL DISPERSIONS OF RARE-EARTH BORATES, PREPARATION THEREOF AND LUMINOPHORES PRODUCED THEREFROM

(75) Inventors: Valerie Buissette, Paris (FR); Thierry Le-Mercier, Rosny-Sous-Bois (FR); Franck Fajardie, Rueil-Malmaison (FR)

Correspondence Address: BUCHANAN, INGERSOLL & ROONEY PC, POST OFFICE BOX 1404, ALEXANDRIA, VA, 22313-1404, US

(73) Assignee: Rhodia Operations, Aubervilliers (FR)

(21) Appl. No.: 12/162,595

(22) PCT Filed: Jan. 29, 2007
(86) PCT No.: PCT/EP07/50810

§ 371 Date: Dec. 11, 2008

(30) Foreign Application Priority Data
Jan. 30, 2006 (FR) 60/00833

(51) Int. Cl. C09K 11/77; C09K 11/08; C09K 11/63

(52) U.S. Cl. 252/301.4 R

(57) ABSTRACT

Colloidal dispersions of rare-earth borates include a liquid phase and borate colloids dispersed therein, these colloids having a mean hydrodynamic diameter of at most 200 nm and consisting essentially of elementary particles having a mean size of less than 100 nm; such dispersions are prepared by: (a) reacting a rare-earth oxide with a controlled amount of a water-soluble monovalent acid, having a pKa of from 2.5 to 5.0; (b) heating the medium thus obtained; (c) adding boric acid to the medium obtained and heating the resulting mixture; and (d) separating the solid product from the liquid medium thus obtained, and redispersing same in a liquid phase (the subject borates are useful luminophores, especially for the manufacture of luminescent transparent materials).

The present invention relates to a colloidal dispersion of a rare-earth metal borate, to its process of preparation and to its use as a luminophore.

The fields of luminescence and of electronics are currently experiencing major developments. Mention may be made, as example of these developments, of the perfecting of plasma systems (screens and lamps) for novel display and lighting techniques. These novel applications require luminophoric materials, such as rare-earth metal borates, exhibiting increasingly improved properties. Thus, in addition to their property of luminescence, these materials are required to have specific characteristics of morphology or of particle size in order in particular to facilitate the use thereof in the desired applications.

More specifically, there is a demand for luminophores provided in the form of particles which are as separate as possible and very fine in size.

Furthermore, and still in the context of development in the fields of luminescence and electronics, there is a desire to obtain materials in the form of transparent films which can emit in various colors but also in the white range.

Sols or colloidal dispersions can constitute an advantageous access route to products of such a type.

The object of the invention is to provide a rare-earth metal borate in the form of a colloidal dispersion.

With this aim, the colloidal dispersion of rare-earth metal borate according to the invention is characterized in that it comprises a liquid phase and colloids of said borate in dispersion in this phase, these colloids exhibiting a mean hydrodynamic diameter, measured by QELS, of at most 200 nm and being substantially composed of an individual particle with a mean size of less than 100 nm.

Moreover, the invention also relates to a process for the preparation of this dispersion which is characterized in that it comprises the following stages:
(a) a rare-earth metal oxide is reacted with a controlled amount of a water-soluble monovalent acid exhibiting a pKa of between 2.5 and 5.0;
(b) the medium obtained on conclusion of the reaction is heated;
(c) boric acid is added to the medium obtained on completion of the preceding stage and the mixture obtained is heated at a temperature of at least 170° C.;
(d) the solid product is separated from the liquid medium thus obtained and is redispersed in a liquid phase, whereby the colloidal dispersion is obtained.

Other characteristics, details and advantages of the invention will become even more fully apparent on reading the description which will follow and also the appended drawings, in which:

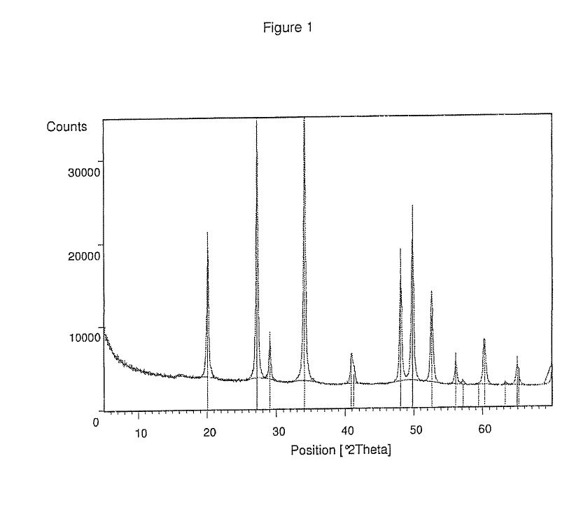

FIG. 1 is an X-ray diagram of a product according to the invention;

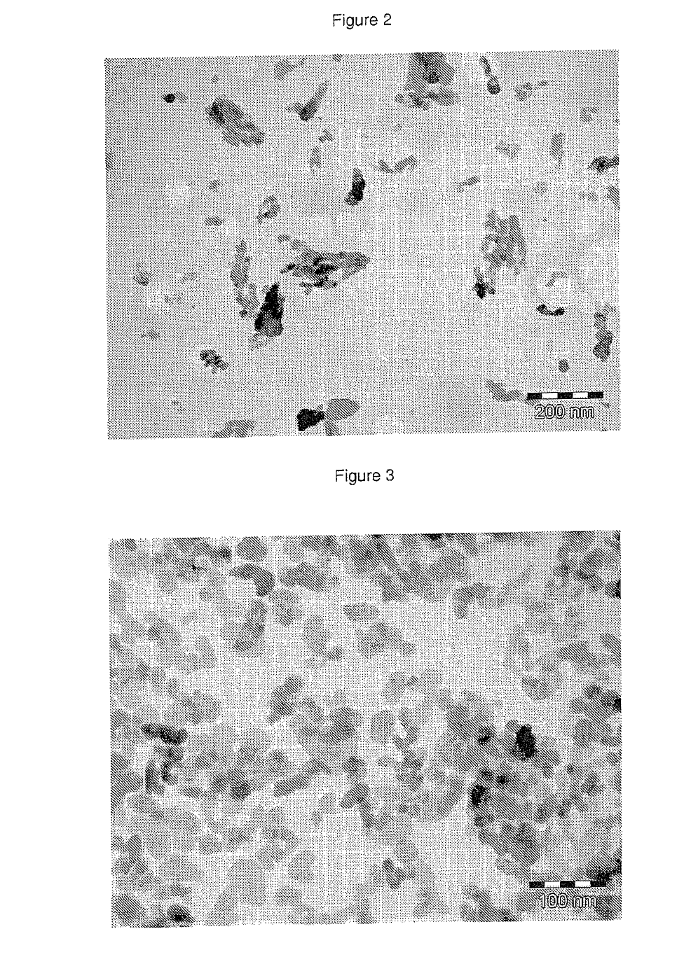

FIG. 2 is a transmission electron microscopy (TEM) photograph of this same product;

FIG. 3 is a transmission electron microscopy (TEM) photograph of another product according to the invention.

The term “rare-earth metal” is understood to mean, in the present description, the elements from the group consisting of scandium, yttrium and the elements of the Periodic Table with an atomic number of between 57 and 71 inclusive.

For the continuation of the description, the expression “colloidal dispersion of a rare-earth metal borate” or “sol of a rare-earth metal borate” denotes any system composed of colloids of this compound, that is to say particles having a size generally of at most approximately 200 nm (mean size determined by quasielastic light scattering (QELS)). These colloids are in stable suspension in a continuous liquid phase, it being possible for said colloids to comprise, as counterions, bonded or adsorbed ions, such as, for example, acetates, nitrates, chlorides or ammoniums. It should be noted that, in such dispersions, the borate can be either completely in the form of colloids or simultaneously in the form of ions or of polyions and in the form of colloids.

The rare-earth metal borate of the invention is of the orthoborate type, of formula LnBO₃, Ln representing at least one rare-earth metal. It is emphasized here that the invention applies to the borates of one or more rare-earth metals. This is why, throughout the description, everything which is described on the subject of a rare-earth metal borate and on the subject of its process of preparation should be understood as also applying to the case where several rare-earth metals are present.

The constituent rare-earth metal of the borate of the invention, that is to say that which forms, with the boron, the matrix of the product, preferably belongs to the group of the rare-earth metals which do not have a luminescence property. Thus, this constituent rare-earth metal of the borate can be chosen, alone or in combination, from the group consisting of yttrium, gadolinium, lanthanum, lutecium and scandium. It can more particularly be yttrium and/or gadolinium.

The borate can additionally comprise one or more doping agents. In a way known per se, the doping agents are used in combination with the matrix in order to give it luminescence properties. These doping agents can be chosen from antimony, bismuth and rare-earth metals. In the latter case, the rare-earth metal or metals used as doping agent are chosen from the group of the rare-earth metals possessing luminescence properties and they are different from the constituent rare-earth metal of the borate. Mention may be made, as doping rare-earth metal, of cerium, terbium, europium, dysprosium, holmium, ytterbium, neodymium, thulium, erbium and praseodymium. Use is more particularly made of terbium, thulium, cerium and europium. The content of doping agent is usually at most 50 mol %, with respect to the rare-earth metal borate matrix ([doping agent]/[ΣLn] ratio), ΣLn representing the combined rare-earth metals and doping agents in the borate.

Finally, the boron of the borate of the invention can be partially replaced by aluminum in an Al/B atomic ratio which can range up to 20%.

As indicated above, the colloids constituting the dispersion of the invention may exhibit a size of at most approximately 200 nm (mean hydrodynamic diameter measured by QELS); this size can more particularly be at most 150 nm and more particularly still at most 100 nm.

According to another main characteristic of the invention, the colloids of the dispersion are composed of individual particles, the mean size of which is less than 100 nm.

Preferably, the mean size of the individual particles is at most 70 nm and it can, more particularly still, be at most 60 nm. By way of example, this size can be between 5 and 100 nm, the latter value being excluded, more particularly between 10 nm and 70 nm and more particularly still between 20 nm and 60 nm. It should be noted that, below 5 nm, the advantage of the product in the field of luminescence may be less significant.

Throughout the description, the mean size of the individual particles is measured by employing the X-ray diffraction (XRD) technique, it being possible for this measurement optionally to be supplemented by a TEM measurement, as indicated below.

The term “individual particle” is understood to mean a particle which is not itself composed of an agglomerate of other smaller particles or which cannot be fractionated into smaller particles by simple deagglomeration. Furthermore, the individual aspect of a particle can also be demonstrated by comparing the mean size of the particles, measured by the TEM technique, with the value of the measurement of the size of the crystal or of the coherent domain obtained from the XRD analysis. It is specified here that the value measured by XRD corresponds to the size of the coherent domain calculated from the width of the two most intense diffraction lines. The Scherrer model, as described in the work Theorie et technique de la radiocristallographie [Theory and Technique of X-ray Crystallography], A. Guinier, Dunod, Paris, 1956,is used for this measurement. By way of example, in the case of YBO₃, they are the diffraction lines corresponding to the (100) and (102) planes. The two values: mean size determined by TEM (t₁) and mean size determined by XRD (t₂) exhibit, for the individual particles of the invention, the same order of magnitude, that is to say, within the meaning of the present description, that they are in a t₁/t₂ ratio of at most 3, more particularly of at most 2.

The colloids of the borate of the invention are composed substantially of an individual particle. This is understood to mean that they exist in the highly distinct and well separated form, the bulk of the colloids, preferably all of the colloids, thus being composed of a single individual particle. However, there may be a degree of agglomeration of the individual particles.

It is considered, within the meaning of the present invention, that the colloids are indeed composed of individual particles by comparing the mean hydrodynamic diameter of the colloids (d₁), measured by QELS, and the abovementioned mean size of the individual particles (t₁), determined by TEM. In the case of well separated colloids, which are thus composed of individual particles, the values obtained by these two techniques exhibit the same order of magnitude, that is to say, within the meaning of the present description, that they are in a d₁/t₁ ratio of at most 4, more particularly of at most 3.

It is specified here that the measurements by QELS (Malvern device) are carried out on the dispersion as is, optionally diluted in water, but without additive of dispersant type and without treatment using ultrasound. The distribution in sizes is given in intensity, according to a monomodal model, with a refractive index of the particles in suspension of 1.8.

According to a preferred characteristic of the invention, the colloids constituting the dispersion are monodispersive. This monodispersity is characterized by a polydispersity index of the colloids, measured by QELS, which is at most 0.6, preferably at most 0.5 and more preferably still at most 0.4.

According to another preferred characteristic of the invention, the individual particles which constitute the colloids are provided in the form of a pure phase. This is understood to mean that the X-ray diagram of the particles reveals only a single crystallographic phase which is that corresponding to LnBO₃. The X-ray diagram thus does not reveal interfering phases, such as oxides or hydroxides.

The liquid phase of the suspensions according to the invention is generally water but this can also be a water/water-miscible solvent mixture or also an organic solvent.

The organic solvent can very particularly be a water-miscible solvent. Mention may be made, for example, of alcohols, such as methanol or ethanol, glycols, such as ethylene glycol, acetate derivatives of glycols, such as ethylene glycol monoacetate, glycol ethers, polyols or ketones.

The liquid phase can also comprise a complexing agent. This is more particularly the case for the aqueous dispersions intended to be transferred into a liquid organic phase or for dispersions in a liquid organic phase.

This complexing agent can be chosen from known complexing agents, for example from alkali metal polyphosphates (Mₙ₊₂PₙO₃ₙ₊₁) or metaphosphates ([MPO₃]ₙ) (M denoting an alkali metal, such as sodium), in particular such as sodium hexametaphosphate. It can also be chosen from alkali metal silicates (sodium silicate), aminoalcohols, phosphonates, citric acid and its salts, derivatives of phosphosuccinic acid ((HOOC)ₙ—R—PO₃H₂, where R is an alkyl residue), polyacrylic, polymethacrylic and polystyrenesulfonic acids and their salts. Preference is very particularly given to citric acid and metaphosphates.

The amount of complexing agent can be between 0.1% and 10%, more particularly between 2.5% and 5%, this amount being expressed as weight of complexing agent with respect to the weight of solid in the dispersion.

The concentration of the dispersion can be, for example, between approximately 10 g/l and approximately 100 g/l, this concentration being expressed as grams of rare-earth metal borate and being given purely by way of indication.

The dispersion of the invention is stable for at least 1 month, that is to say that no separation on settling is observed at the end of this time.

The invention also relates to a borate which is provided in the solid form, that is to say in the form of a powder, and which can be obtained by drying the dispersion as described above. This powder has the property of being redispersible, that is to say of being able to be redispersed in water, so that, after putting back into water and optionally a gentle treatment with ultrasound, for example for 5 minutes at low power (100 W), a colloidal dispersion is obtained which exhibits all the characteristics which were described above (in particular size of the individual particles).

The process of the preparation of the dispersion according to the invention will now be described.

This process comprises a first stage, stage (a), in which a rare-earth metal oxide is reacted with a specific acid. It should be noted here that, in the case of the preparation of a dispersion of a borate comprising a doping agent or a replacement for the boron, use is then made, in addition to the oxide of the constituent rare-earth metal of the borate, of an oxide of the doping element or replacement. Likewise, in the case of the preparation of a borate LnBO₃ in which Ln represents several rare-earth metals, use is made of oxides of each of the rare-earth metals concerned.

It is desirable for the oxide employed to be of high purity, preferably with a purity of greater than or equal to 99%, and use is more preferably made of an oxide having a purity of 99.99%. The rare-earth metal oxide is generally provided in the form of a fine powder having a particle size of a few microns and having a mean diameter generally lying between 1 and 5 μm (laser particle sizing). The mean diameter is defined here as being a diameter such that 50% by weight of the particles have a diameter greater than or less than the mean diameter.

A preferred alternative form of the process of the invention consists in employing a rare-earth metal oxide which has been calcined at a temperature of between 850° C. and 1050° C. The calcination time is preferably between 2 and 4 hours.

As regards the acid, the choice thereof is related to the fact that it has to be soluble in water, be monovalent and exhibit a pKa chosen between 2.5 and 5.0.

Acetic acid is entirely well suited to the implementation of the process of the invention.

Recourse is preferably had to an acid devoid of impurities. Its initial concentration is not critical and it can be used diluted, for example 1N, or concentrated up to 17N. Generally, the concentration of the solution of said acid is chosen to be between 1N and 4N as it constitutes the medium for dispersion of the rare-earth metal oxide and thus has to constitute a liquid phase which is sufficiently large in volume to allow attack to take place under good stirring conditions.

The amount of acid used is an important element of the process of the invention. It has to be in deficit with respect to stoichiometry, which means that the molar ratio of the acid employed to the rare-earth metal oxide (or the combined rare-earth metal oxides, in the case of borates comprising several rare-earth metals), expressed as metal cation, is less than 2.5 and greater than 1. The low limit is defined in view of the economic requirements of good reaction yield and good reaction kinetics. Preferably, said molar ratio is chosen to be between 1.1 and 2.2 and preferably between 1.2 and 1.8.

According to a practical embodiment of the invention, the rare-earth metal oxide is added to the solution of the acid, the concentration of which is adjusted so that it corresponds to that which is indicated above.

According to another embodiment, the rare-earth metal oxide is suspended in water and an appropriate amount of the acid is subsequently added. In both cases, this operation is carried out with stirring and at a temperature which can be ambient temperature (15° C.-25° C.) or also a higher temperature.

The second stage (stage b) of the process of the invention consists in heating the medium resulting from stage (a). This heating is generally carried out at a temperature lying between 50° C. and the reflux temperature of the reaction medium. Preferably, the heat treatment is carried out between 70° C. and 100° C. The duration of said treatment is highly variable and becomes shorter as the temperature increases. Once the reaction temperature has been reached, it is maintained for 1 to 4 hours and preferably for 3 to 4 hours.

It should be noted here, still in the case of the preparation of a dispersion of a borate comprising a doping agent or a replacement, that it is possible to add the doping agent or the replacement for the boron, at this point in the progression of the process and to the medium obtained, in the form, for example, of a salt, such as a nitrate, this being the case if the doping agent or the replacement has not been added previously in the form of an oxide, as described above.

In the third stage (stage c) of the process of the invention, boric acid is added to the medium obtained on conclusion of the preceding stage. This acid is added in an amount which can vary within a wide range, preferably in an amount such that the B/Ln molar ratio is between 0.9 and 2, as, in this case, the borate is optimally obtained in the form of a pure phase.

The mixture thus formed is subsequently heated at a temperature which is at least 170° C., preferably between 180° C. and 200° C. A temperature of at least 180° C. readily results in a highly crystalline product. Below 170° C., there is a risk of the borate being amorphous.

The heating operation is carried out by introducing the liquid medium into a closed chamber (closed reactor of the autoclave type) preferably equipped with a stirring system.

Heating can be carried out either under air or under an inert gas atmosphere, preferably N₂.

The duration of heating is not critical and can thus vary within wide limits, for example between 1 and 48 hours, preferably between 2 and 24 hours. Likewise, the rise in temperature takes place at a rate which is not critical and the set reaction temperature can thus be reached by heating the medium, for example, between 30 minutes and 4 hours, these values being given entirely by way of indication, it being understood that it is necessary to heat for a sufficient period of time and at a sufficient temperature to form the desired orthoborate phase.

For the final stage of the process (stage d), the solid product is separated from the liquid medium obtained at the end of the heating of stage (c). This separation is carried out according to known solid/liquid separation techniques: filtration, separation by settling or centrifuging, preferably.

The product thus separated can advantageously be washed. It is thus possible to carry out two successive solid/liquid separations and to wash the separated product on conclusion of the first separation by redispersing it in water.

In the case of a dispersion comprising a complexing agent, this complexing agent can be added again during the washing.

Finally, the product is redispersed in water with optionally a gentle treatment using ultrasound, for example for 5 minutes at low power (100 W). Preferably, the redispersing is carried out in water at neutral pH, and a dispersion according to the invention is thus obtained.

In the case of a dispersion partially or completely in a solvent medium other than water, this dispersion can be prepared starting from an aqueous dispersion as obtained by the process which has just been described and by addition of the organic solvent of the abovementioned type to this aqueous dispersion, followed by distillation in order to remove the water.

The description which has just been given relates to the preparation of the borate in the form of a colloidal dispersion. In order to obtain the borate of the invention in the form of a powder, this dispersion is taken as starting material and is dried by any known means, preferably at a rather low temperature, that is to say of at most 120° C., in an oven, for example. The solid product thus obtained can be resuspended in water to give a colloidal dispersion according to the invention, as indicated above.

Because of its properties and the nature of the doping agent, Eu, Ce, Tb and Tm, for example, the borates of the invention (this is understood to mean, and for the continuation of the description, the borates in the form of a colloidal dispersion or the borates in the solid form or also the borates obtained by the process of preparation which has been described above) can be used directly or indirectly (that is to say, in the latter case, after heat treatment) as luminophores. These borates exhibit luminescence properties under electromagnetic excitation in the wavelength range used in plasma systems (screens and lamps where excitation is caused by a rare gas or a mixture of rare gases, such as xenon and/or neon) and in mercury vapor lamps in the case of borates doped with cerium and terbium in combination. For this reason, they can be used as luminophores in plasma systems (display screen or lighting system) or in mercury vapor lamps. In the specific case of borates doped with cerium and terbium, these products can also be used as luminophores in electroluminescent diodes having UV excitation.

The invention thus also relates to luminescent devices, in particular comprising the borate of the invention, within the meaning given in the preceding section, or to the devices manufactured using this same borate. Likewise, the invention relates to plasma systems, mercury vapor lamps or electroluminescent diodes where it is possible for the borate to be included in the manufacture thereof or which comprise this same borate. The use of the luminophores in the manufacture of plasma systems takes place according to well known techniques, for example by silk screen printing, electrophoresis or sedimentation.

The particle size properties of the borates of the invention mean that they can be used as markers in transparent inks, using mechanisms by addition of protons (up-conversion) in the IR/visible region or luminescence in the IR region, for example for producing labeling by an invisible bar code system. In this case, the doping agent pair will preferably be Yb and Er. A similar use but employing UV excitation is also possible with, in this case, thulium alone or the cerium/terbium pair as doping agent.

The borates of the invention can also be used as markers in a material of the paper, board, textile or glass type or also a macromolecular material. The latter can have different natures: elastomeric, thermoplastic, thermosetting.

Moreover, the specific properties of these borates, when they are not doped, in the visible and UV region (no absorption), mean that they can be used as reflective barrier in light fixtures comprising mercury vapor or plasma systems.

The invention also relates to a luminescent material which comprises or which can be manufactured using at least one borate according to the invention, that is to say, here again, in the form of a colloidal dispersion or in the solid form or also as obtained by the preparation process described above.

According to a preferred embodiment, this luminescent material can additionally be transparent.

It should be noted that this material can comprise or can be manufactured using, in addition to the borate of the invention, other borates or more generally other luminophores in the form of submicron or nanometric particles.

This material can be provided in two forms, that is to say either in a bulk form, the whole of the material exhibiting the properties of transparency and of luminescence, or in a composite form, that is to say, in this case, in the form of a substrate and of a layer on this substrate, the layer then exhibiting alone these properties of transparency and of luminescence. In this case, the borate of the invention is present in said layer.

The substrate of the invention is a substrate which can be made of silicon, based on a silicone or made of quartz. It can also be a glass or also a polymer, such as polycarbonate. The substrate, for example the polymer, can be provided in a rigid form and in a form of a sheet or of a plate with a thickness of a few millimeters. It can also be provided in the form of a film with a thickness of a few tens of microns, indeed even a few microns, to a few tenths of a millimeter.

The term “transparent material” is understood to mean, within the meaning of the invention, a material which exhibits a haze of at most 50% and a total transmission of at least 60%, preferably a haze of at most 30% and a total transmission of at least 80% and more preferably still a haze of at most 20% and a total transmission of at least 85%. The total transmission corresponds to the total light amount which passes through the layer, with respect to the amount of incident light. The haze corresponds to the ratio of the diffuse transmission of the layer to its total transmission.

These two quantities are measured under the following conditions: the layer of material with a thickness of between 0.2 μm and 1 μm is positioned on a standard glass substrate with a thickness of 0.5 mm. The fraction by weight of borate particles in the material is at least 20%. The total transmission and the diffuse transmission are measured through the layer of the material and substrate using a conventional procedure on a Perkin Elmer Lamda 900 spectrometer equipped with an integration sphere for a wavelength of 550 nm.

The material, and more particularly the abovementioned layer, can comprise, in addition to a borate according to the invention, binders or fillers of the following types: polymer (polycarbonate, methacrylate), silicate, silica bead, phosphate, titanium oxide or other inorganic fillers, in order to improve in particular the mechanical and optical properties of the material.

The fraction by weight of borate particles in the material can be between 20% and 99%.

The thickness of the layer can be between 30 nm and 10 μm, preferably between 100 nm and 3 μm and more preferably still between 100 nm and 1 μm.

The material, it its composite form, can be obtained by deposition of a borate dispersion of the invention on the substrate, optionally washed beforehand, for example with a sulfuric acid/chromic acid mixture, or also subjected beforehand to a hydrophilizing plasma treatment. It is also possible to add, during this deposition, the binders or fillers mentioned above. This deposition can be carried out by a spraying, spin-coating or dip-coating technique. After deposition of the layer, the substrate is dried in the air and it can optionally subsequently be subjected to a heat treatment. The heat treatment is carried out by heating at a temperature which is generally at least 200° C. and which has an upper value set in particular by taking into account the compatibility of the layer with the substrate, so as in particular to avoid side reactions. The drying and the heat treatment can be carried out under air, under an inert atmosphere, under vacuum or also under hydrogen.

It has been seen above that the material can comprise binders or fillers. It is possible, in this case, to use suspensions which themselves comprise at least one of these binders or of these fillers or also precursors of these.

The material according to the bulk form can be obtained by incorporation of the borate particles in a matrix of polymer type, for example, such as polycarbonate or polymethacrylate, or a silicone.

Finally, the invention relates to a luminescent system which comprises a material of the type described above and, in addition, a source of excitation which can be a source of UV photons, such as a UV diode, or also an excitation of the following type: Hg, rare gases or X-rays.

The system can be used as transparent wall lighting device of the illuminating glazing type.

Examples will now be given.

### EXAMPLE 1

This example relates to a europium yttrium borate (Y,Eu)BO₃, which is a red luminophore.

A 2 mol/l aqueous acetic acid solution (55.44 g of acetic acid made up to 462 ml with water) is brought to reflux. 82.5 g of a (Y,Eu)₂O₃ powder with a composition by weight of rare-earth metal oxides: Y 95%, Eu 5%, is added. The mixture is left to mature at reflux for 4 h. The final medium obtained is recovered and the rare-earth metal concentration of this solution is 1.5 mol/l. The mixture is allowed to cool. 2.772 l of 0.5 mol/l boric acid H₃BO₃ are subsequently added. The mixture is placed in an autoclave and brought to 180° C. with stirring for 17 h. On conclusion of this treatment, the product is subsequently washed with water by centrifuging and resuspended in water. The colloidal dispersion according to the invention is then obtained.

The colloidal dispersion obtained is highly luminescent in the orange-red region under UV and V/UV excitation.

X-ray diffraction carried out on the product dried in an oven at 60° C. (FIG. 1) shows that the product is composed of a pure phase of YBO₃ type. The size of the crystallites, measured by the Scherrer law, is 31 nm for the diffraction line corresponding to the (102) plane and 37 nm for the diffraction line corresponding to the (100) plane.

The quasielastic light scattering measurement carried out on the dispersion (distribution in intensity, monomodal model, refractive index=1.8) gives a mean hydrodynamic diameter D₅₀=130 nm, with a polydispersity index of 0.5.

The TEM microscopy negative (FIG. 2) shows the presence of particles with a mean (number) size of 50 nm.

### EXAMPLE 2

This example relates to a terbium yttrium borate (Y,Tb)BO₃, which is a green luminophore.

A 2 mol/l aqueous acetic acid solution (55.44 g of acetic acid made up to 462 ml with water) is brought to reflux. 80.17 g of a Y₂O₃ powder are added. The mixture is left to mature at reflux for 4 h. The final medium obtained is recovered and the concentration of rare-earth metal in this solution is 1.5 mol/l. The mixture is allowed to cool. 9 ml of 2M terbium nitrate Tb(NO₃)₃ solution (i.e., 0.018 mol of terbium) are added to 70.4 ml of this solution (0.106 mol of yttrium). 600 ml of 0.5 mol/l boric acid H₃BO₃ (i.e., 0.3 mol) are subsequently added. The mixture is placed in an autoclave and brought to 180° C. with stirring for 17 h. On conclusion of this treatment, the product is subsequently washed with water by centrifuging and resuspended in water. The colloidal dispersion according to the invention is then obtained.

The colloidal dispersion obtained is highly luminescent in the green region under UV and V/UV excitation.

X-ray diffraction carried out on the product dried in an oven at 60° C. shows that the product is composed of a pure phase of YBO₃ type. The size of the crystallites, measured by the Scherrer law, is 22 nm for the diffraction line corresponding to the (102) plane and 31 nm for the diffraction line corresponding to the (100) plane.

The quasielastic light scattering measurement carried out on the dispersion (distribution in intensity, monomodal model, refractive index=1.8) gives a mean hydrodynamic diameter D₅₀=133 nm, with a polydispersity index of 0.4.

The TEM microscopy negative (FIG. 3) shows the presence of particles with a mean (number) size of 50 nm.

### EXAMPLE 3

This example relates to a gadolinium terbium yttrium borate (Y,Gd,Tb)BO₃, which is a green luminophore.

A 2 mol/l aqueous acetic acid solution (12 g of acetic acid made up to 100 ml with water) is brought to reflux. 20.34 g of a (Y,Gd,Tb)₂O₃ powder with a composition by weight of rare-earth metal oxides: Y 61.3%, Gd 17.1% and Tb 21.2%, are added. The mixture is left to mature at reflux for 4 h. The final medium obtained is recovered and the concentration of rare-earth metal in this solution is 1.5 mol/l. The mixture is allowed to cool. 52 ml of 0.5 mol/l boric acid H₃BO₃ (i.e., 0.026 mol) are subsequently added to 10 ml of this solution (0.013 mol of rare-earth metals). The mixture is placed in an autoclave and brought to 200° C. for 17 h. On conclusion of this treatment, the product is subsequently washed with water by centrifuging and resuspended in water. The colloidal dispersion according to the invention is then obtained.

The colloidal dispersion obtained is highly luminescent in the green region under UV and V/UV excitation.

X-ray diffraction carried out on the product dried in an oven at 60° C. shows that the product is composed of a pure phase of YBO₃ type. The size of the crystallites, measured by the Scherrer law, is 38 nm for the diffraction line corresponding to the (102) plane and 43 nm for the diffraction line corresponding to the (100) plane.

The quasielastic light scattering measurement carried out on the dispersion (distribution in intensity, monomodal model, refractive index=1.8) gives a mean hydrodynamic diameter D₅₀=150 nm, with a polydispersity index of 0.5.

The TEM microscopy negative shows the presence of particles with a mean (number) size of 50 nm.

### EXAMPLE 4

This example relates to a thulium yttrium borate (Y,Tm)BO₃.

A 2 mol/l aqueous acetic acid solution (55.44 g of acetic acid made up to 462 ml with water) is brought to reflux. 80.17 g of a Y₂O₃ powder are added. The mixture is left to mature at reflux for 4 h. The final medium obtained is recovered and the concentration of rare-earth metal in this solution is 1.5 mol/l. The mixture is allowed to cool. 12.08 ml of 0.0745M thulium nitrate Tm(NO₃)₃ solution (i.e., 0.0009 mol of thulium) are added to 9.4 ml of this solution (0.0141 mol of yttrium). 60 ml of 0.5 mol/l boric acid H₃BO₃ (i.e., 0.03 mol) are subsequently added. The mixture is placed in an autoclave and brought to 200° C. for 17 h. On conclusion of this treatment, the product is subsequently washed with water by centrifuging and resuspended in water. The colloidal dispersion according to the invention is then obtained.

X-ray diffraction carried out on the product dried in an oven at 60° C. shows that the product is composed of a pure phase of YBO₃ type. The size of the crystallites, measured by the Scherrer law, is 31 nm for the diffraction line corresponding to the (102) plane and 43 nm for the diffraction line corresponding to the (100) plane.

The quasielastic light scattering measurement carried out on the dispersion (distribution in intensity, monomodal model, refractive index=1.8) gives a mean hydrodynamic diameter D₅₀=145 nm, with a polydispersity index of 0.5.

The TEM microscopy negative shows the presence of particles with a mean (number) size of approximately 50 nm.

### EXAMPLE 5

This example relates to the preparation of a transparent and luminescent thin nanocomposite film based on nanoparticles of (Y,Eu)BO₃ and silica.

The dispersion of example 1 (3 ml at 30 g/l) is mixed with a 10% by weight solution of lithium polysilicate in water in proportions such that the silicate/borate ratio is 10% by weight. The mixture is deposited on a glass substrate, hydrophilized beforehand (plasma treatment for 30 seconds), by spin coating (1900 rev/min for 65 seconds). The film is subsequently dried at 120° C. in an oven for 1 h. Two successive depositions are carried out. The thickness of the layer after deposition is approximately 300 nm.

A film which is transparent and luminescent to the eye under UV excitation is obtained.

The film has a total transmission of 90.6% and a haze of 3% at 550 nm (values measured under the conditions described above). The film luminesces in the red region under UV excitation (230 nm) and V/UV excitation (172 nm). The luminosity and the transparency of the films is not detrimentally affected after a heat after-treatment (at 450° C. for 1 h), and under UV irradiation (24 h at 230 nm).

1.-22. (canceled)

23. A colloidal dispersion of at least one rare-earth metal borate, which comprises a liquid phase and colloids of said at least one borate dispersed therein, said colloids having a mean hydrodynamic diameter, measured by QELS, of at most 200 nm and comprising individual particles having a mean particle size of less than 100 nm.

24. The colloidal rare-earth metal borate dispersion as defined by claim 23, said individual particles having a mean particle size of at most 70 nm.

25. The colloidal rare-earth metal borate dispersion as defined by claim 23, said individual particles having a mean particle size of at most 60 nm.

26. The colloidal rare-earth metal borate dispersion as defined by claim 23, said individual particles comprising a pure phase thereof.

27. The colloidal rare-earth metal borate dispersion as defined by claim 23, said at least one rare-earth metal borate comprising a rare-earth metal selected from the group consisting of yttrium, gadolinium, lanthanum, lutecium and scandium.

28. The colloidal rare-earth metal borate dispersion as defined by claim 23, further comprising, as doping agent therefor, at least one element selected from the group consisting of antimony, bismuth and rare-earth metals other than the constituent rare-earth metal(s) of the borate.

29. The colloidal rare-earth metal borate dispersion as defined by claim 23, having a content of doping element of at most 50 mol %.

30. The colloidal rare-earth metal borate dispersion as defined by claim 23, said at least one rare-earth metal borate comprising aluminum as a replacement for a fraction of the boron.

31. The colloidal rare-earth metal borate dispersion as defined by claim 23, said liquid phase comprising water.

32. The colloidal rare-earth metal borate dispersion as defined by claim 23, said colloids comprising the separated form thereof, the mean hydrodynamic diameter of the colloids (d₁), measured by QELS, and the mean size of the individual particles (t₁), determined by TEM, being in a d₁/t₁ ratio of at most 4.

33. The colloidal rare-earth metal borate dispersion as defined by claim 23, said colloids having a polydispersity index which is at most 0.6.

34. A rare-earth metal borate, comprising a redispersible powder obtained by drying the colloidal rare-earth metal borate dispersion as defined by claim 23.

35. A process for the preparation of a colloidal dispersion as defined by claim 23, which comprises the following stages:
(a) reacting a rare-earth metal oxide and optionally an oxide of a doping agent and/or replacement element therefor with a controlled amount of a water-soluble monovalent acid having a pKa of from 2.5 to 5.0;
(b) heating the medium thus obtained;
(c) adding boric acid to the medium thus obtained and heating the resulting mixture at a temperature of at least 170° C.; and
(d) separating the solid product from the liquid medium thus obtained and redispersing same in a liquid phase.

36. The process as defined by claim 35, said monovalent acid comprising acetic acid.

37. The process as defined by claim 35, wherein the amount of acid in stage (a) is such that the molar ratio of the said acid to the rare-earth metal oxide, expressed as metal cation, is less than 2.5 and greater than 1.

38. The process as defined by claim 35, wherein the heating stage (b) is carried out at a temperature ranging from 50° C. to the reflux temperature of the reaction medium.

39. A luminescent device produced from a colloidal rare-earth metal borate dispersion as defined by claim 23.

40. A plasma system produced from a colloidal rare-earth metal borate dispersion as defined by claim 23.

41. A mercury vapor lamp produced from a colloidal rare-earth metal borate dispersion as defined by claim 23.

42. An electroluminescent diode produced from a colloidal rare-earth metal borate dispersion as defined by claim 23.

43. A luminescent material produced from a colloidal rare-earth metal borate dispersion as defined by claim 23.

44. A luminescent system comprising a material as defined by claim 43 and a source of excitation thereof.

45. The colloidal rare-earth metal borate dispersion as defined by claim 28, said at least one doping agent comprising cerium, terbium, europium, thulium, erbium and/or praseodymium.

46. The colloidal rare-earth metal borate dispersion as defined by claim 32, said ratio being at most 3.

47. The colloidal rare-earth metal borate dispersion as defined by claim 33, said polydispersity index being at most 0.4.

48. A luminescent device, material and/or system comprising the at least one rare-earth borate as defined by claim 34.

49. A plasma system, mercury vapor lamp or electroluminescent diode comprising the at least one rare-earth borate as defined by claim 34.
